(19) United States
(12) Patent Application Publication
(10) Pub. No.: US 2026/0196055 A1
(43) Pub. Date: Jul. 9, 2026

(54) EXTERNAL WORLD RECOGNITION DEVICE AND EXTERNAL WORLD RECOGNITION METHOD

(71) Applicant: Hitachi Astemo, Ltd., Hitachinaka-shi, Ibaraki (JP)

(72) Inventors: Hideaki KIDO, Chiyoda-ku, Tokyo (JP); Kota IRIE, Hitachinaka-shi, Ibaraki (JP); Hirotomo SAI, Hitachinaka-shi, Ibaraki (JP)

(73) Assignee: Hitachi Astemo, Ltd., Hitachinaka-shi, Ibaraki (JP)

(21) Appl. No.: 18/863,765

(22) PCT Filed: Apr. 12, 2023
(86) PCT No.: PCT/JP2023/014887

§ 371 Date: Nov. 7, 2024

(30) Foreign Application Priority Data
Jun. 27, 2022 (JP) 2022-102526

(51) Int. Cl. G06V 20/56; G06T 7/73; G06V 10/80

(52) U.S. Cl. CPC G06V 20/56; G06T 7/75; G06V 10/80

(57) ABSTRACT

An external world recognition device includes: an imaging plane estimation unit that estimates an imaging plane in the first image on a basis of a detection result of the landmark by the first landmark detection unit; an image transform estimation unit that estimates an image transform parameter matching an imaging plane in the second image on a basis of information on the imaging plane estimated by the imaging plane estimation unit and imaging parameters of the plurality of imaging units; a feature collation unit that collates a feature of the landmark detected from the first image subjected to image transform using an image transform parameter by the image transform estimation unit with a feature of the landmark detected from the second image; and a position estimation unit that estimates a three-dimensional position of the landmark on a basis of a collation result of the feature collation unit.

### TECHNICAL FIELD

The present invention relates to an external world recognition device and an external world recognition method.

### BACKGROUND ART

In realization of automatic driving and advanced driving support systems, importance of a camera that monitors an external world of a vehicle and detects an obstacle on a travel route and an object necessary for traveling of the vehicle such as lane information of the travel route is increasing. In particular, in order to improve object detection performance, a plurality of cameras are mounted on a vehicle, and a function of acquiring information around the vehicle from the cameras and recognizing a surrounding situation is realized.

As a type of such a camera that recognizes the external world, for example, there is a stereo camera using a plurality of cameras. In the stereo camera, two cameras are arranged in a vehicle at predetermined intervals. Then, the distance to the captured object can be measured using the parallax of the overlapping region of the images captured by the two cameras.

The stereo cameras include a parallel stereo camera in which optical axes of two cameras are installed in parallel, a non-parallel stereo camera in which optical axes are installed in non-parallel, and the like. Furthermore, a camera system using two or more cameras may be referred to as a multiview stereo system.

An electronic control device (hereinafter, referred to as an electronic control unit (ECU)) mounted on a vehicle can grasp a possibility of contact with an object in front of the vehicle by measuring a distance to the object using a plurality of images captured by a plurality of cameras. However, even if two cameras located at different positions capture the same object, the appearance of the object is generally different between the two cameras. In a case where images having different appearances are collated with each other, and there is a pattern similar to a pattern having a different appearance between one image and the other image, there is a possibility that the image is collated at a wrong position.

If the image is collated at a wrong position, the distance to the object measured on the basis of the collation result may be wrong, leading to erroneous control of the vehicle. If the model of the shape and the plane of the object in the real world is known, the appearance on each image is geometrically obtained. Therefore, it is considered that erroneous collation can be suppressed by predicting and collating the shape, the plane, and the like.

PTL 1 describes that “viewpoint conversion is performed in which at least one of a first image captured by a first camera and a second image captured by a second camera is deformed to convert the first image and the second image into an image from a common viewpoint and then a plurality of corresponding points are extracted, and geographic calibration is performed on the first camera and the second camera using coordinates of the plurality of corresponding points in the first image and the second image before viewpoint conversion”.

Furthermore, PTL 2 describes that “Since the stereo camera image information captured by the imaging means is obtained by capturing an image of a monitoring target surface such as a road surface or a floor surface in a downward direction, the image information is made to face the monitoring target surface more than the conventional stereo camera image information by the stereo camera installed in a substantially horizontal direction, and the 3D distance image information is further generated on the basis of the parallelized image information obtained by performing the parallelization transform processing on the downward stereo camera image information. Therefore, the 3D distance image information becomes a bird's eye image looked down from above with respect to the monitoring target surface, so that the distance to the road surface or the floor surface can be obtained with high accuracy”.

### CITATION LIST

### Patent Literature

PTL 1: JP 2020-12735 A
PTL 2: JP 2019-16308 A

### SUMMARY OF INVENTION

### Technical Problem

While it is appropriate to change the method of calculating the distance from the own vehicle to the object for each object appearing in the image, the techniques disclosed in PTLs 1 and 2 perform processing on the assumption that a specific object appears in a specific place in the image. For this reason, in a case where an unspecified object appears at a specific place in the image, the distance to the object may be erroneously measured. Furthermore, in the techniques disclosed in PTLs 1 and 2, even if the distance to the object facing the own vehicle can be calculated, the distance of the object (for example, side walls, guardrails) or the like not facing the own vehicle may be wrong.

The present invention has been made in view of such a situation, and an object of the present invention is to enable estimation of a distance to an unspecified landmark even in a case where the landmark appears in two images that look different.

### Solution to Problem

An external world recognition device according to the present invention includes: a first landmark detection unit that detects a landmark on a basis of a first image acquired from at least a first imaging unit among a plurality of imaging units in which at least a part of an imaging visual field with respect to an external world overlaps; a second landmark detection unit that detects a landmark on a basis of a second image acquired from a second imaging unit among the plurality of imaging units; an imaging plane estimation unit that estimates an imaging plane in the first image on a basis of a detection result of the landmark by the first landmark detection unit; an image transform estimation unit that estimates an image transform parameter matching an imaging plane in the second image on a basis of information on the imaging plane estimated by the imaging plane estimation unit and imaging parameters of the plurality of imaging units; a feature collation unit that collates a feature of the landmark detected from the first image subjected to image transform using an image transform parameter by the image transform estimation unit with a feature of the landmark detected from the second image; and a position estimation unit that estimates a three-dimensional position of the landmark on a basis of a collation processing result of the feature collation unit.

### Advantageous Effects of Invention

According to the present invention, even in a case where an unspecified landmark appears in two images having different appearances, the distance to the landmark can be estimated.

Objects, configurations, and effects besides the above description will be apparent through the explanation on the following embodiments.

### BRIEF DESCRIPTION OF DRAWINGS

FIG. 1A is a diagram illustrating a position of a camera mounted on a vehicle according to a first embodiment of the present invention.

FIG. 1B is a diagram illustrating a world coordinate system based on a vehicle according to the first embodiment of the present invention.

FIG. 1C is a diagram illustrating an image coordinates system according to the first embodiment of the present invention.

FIG. 2 is a diagram illustrating an example of an image of a foreground of a vehicle captured by a front camera and a left camera according to the first embodiment of the present invention.

FIG. 3 is a block diagram illustrating an internal configuration example of an external world recognition device according to the first embodiment of the present invention.

FIG. 4 is a block diagram illustrating a hardware configuration example of a computer according to the first embodiment of the present invention.

FIG. 5A is a diagram illustrating an example of an image captured by the front camera according to the first embodiment of the present invention, in which another vehicle, a person, a guardrail, and a side wall are reflected in a straight traveling direction.

FIG. 5B is a diagram illustrating an example of an image captured by the front camera according to the first embodiment of the present invention, in which another vehicle is reflected obliquely in front of the own vehicle.

FIG. 6 is a diagram illustrating an example of processing of a feature collation unit according to the first embodiment of the present invention.

FIG. 7 is a diagram illustrating a state of processing in which the feature collation unit according to the first embodiment of the present invention performs template matching using a left camera image and a front camera image.

FIG. 8 is a block diagram illustrating an internal configuration example of an external world recognition device according to a second embodiment of the present invention.

FIG. 9 is a block diagram illustrating an internal configuration example of an external world recognition device according to a third embodiment of the present invention.

FIG. 10 is a diagram illustrating an example of a region where a vehicle and a background are mixed according to the third embodiment of the present invention.

FIG. 11 is a block diagram illustrating an internal configuration example of an external world recognition device according to a fourth embodiment of the present invention.

FIG. 12 is a block diagram illustrating an internal configuration example of a geometric transform estimation unit and a feature collation unit according to a modification of the external world recognition device according to the fourth embodiment of the present invention.

FIG. 13 is a block diagram illustrating an internal configuration example of an external world recognition device according to a fifth embodiment of the present invention.

### DESCRIPTION OF EMBODIMENTS

Hereinafter, embodiments of the present invention will be described with reference to the accompanying drawings. In the present specification and the drawings, components having substantially the same function or configuration are denoted by the same reference numerals, and redundant description is omitted. The present invention is applicable to, for example, a computing device for vehicle control with which an advanced driver assistance system (ADAS) or an in-vehicle electronic control unit (ECU) for autonomous driving (AD) can communicate.

### First Embodiment

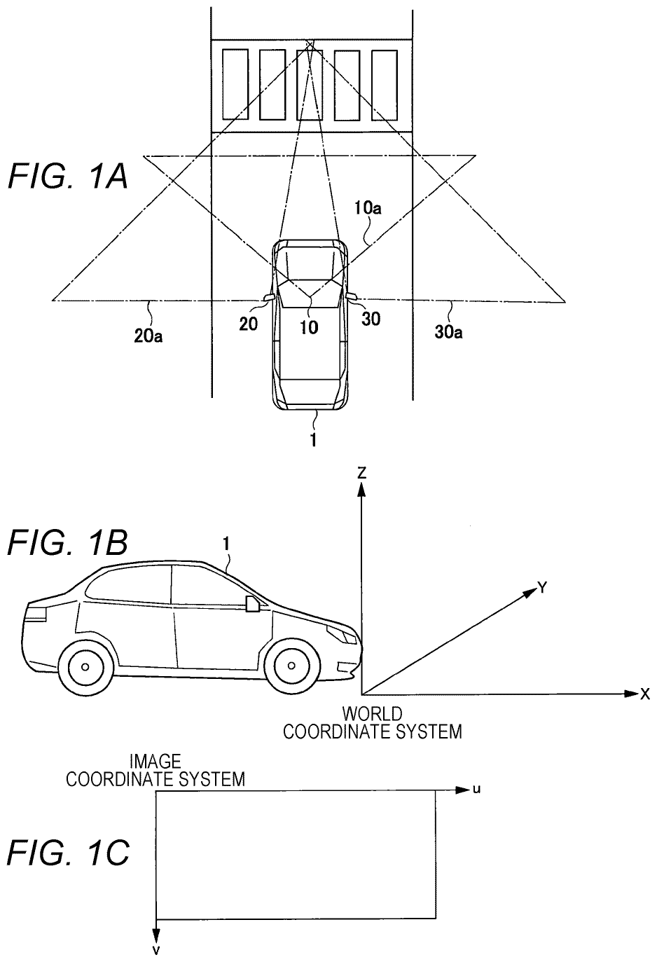

FIGS. 1A, 1B, and 1C are diagrams illustrating a position of a camera mounted on a vehicle 1 according to a first embodiment, a world coordinate system based on the vehicle 1, and an image coordinates system.

FIG. 1A illustrates a configuration example in which a front camera 10, a left camera 20, and a right camera 30 are provided on the front, left side, and right side of the vehicle 1, respectively. In the following description, in a case where the front camera 10, the left camera 20, and the right camera 30 are not distinguished, they are also simply referred to as “cameras”.

In FIG. 1A, an imaging range 10a of the front camera 10, an imaging range 20a of the left camera 20, and an imaging range 30a of the right camera 30 are illustrated by being divided by a one-dot chain line. The imaging ranges 10a and 20a partially overlap. Similarly, the imaging ranges 10a and 30a partially overlap, and the imaging ranges 20a and 30a partially overlap. In these overlapping ranges, the same object appears in the images captured by the respective cameras.

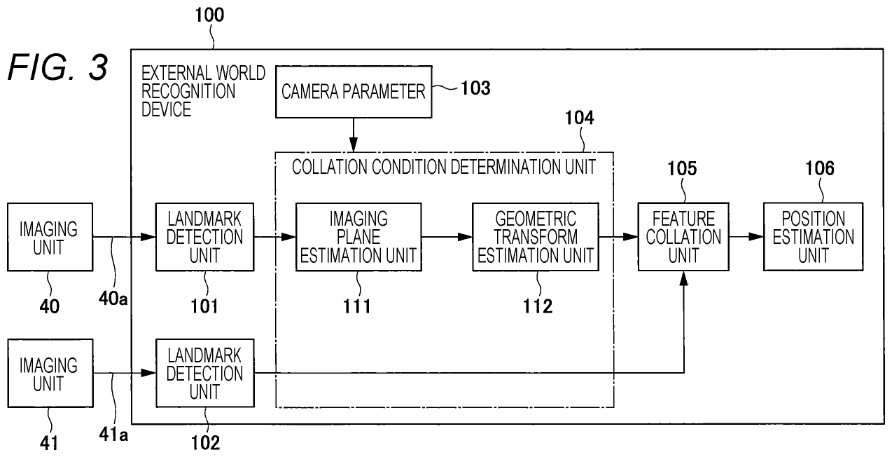

From an image captured by a camera installed in the vehicle 1, an ECU (external world recognition device 100 illustrated in FIG. 3 to be described later) mounted on the vehicle 1 estimates and acquires object information of an object present around the vehicle 1, such as a pedestrian, another vehicle, a white line, or a road surface, and physical quantities such as a distance from the vehicle 1 to the object, a size of the object, and a speed of the object. Then, another ECU (not illustrated automatic driving control ECU) determines a control amount of the vehicle 1 on the basis of the acquired physical quantity, and performs automatic driving, driving support, and the like of the vehicle 1. In the following description, an object (road surface, person, guardrail, white line, etc.) that may affect traveling of vehicle 1 is referred to as a “landmark”.

FIG. 1B illustrates an example of a world coordinate system with the position of the vehicle 1 as an origin. In this world coordinate system, an X axis is taken in a traveling direction of the vehicle 1, a Y axis is taken in a horizontal direction orthogonal to the X axis, and a Z axis is taken in a vertical direction. The position of the landmark other than the vehicle 1 is estimated by the world coordinate system. Therefore, the distance from the vehicle 1 to the landmark is also estimated.

There are several methods for estimating the distance from the vehicle 1 to the landmark. As a representative distance estimation method, there is a method of measuring a distance to a landmark by the principle of triangulation in a case where a plurality of cameras capture the images of the same landmark. In this method, an arbitrary point in the world coordinates existing on the road is set as a transposed matrix X=(X, Y, Z, 1)^{T} in a homogeneous coordinate system, an external parameter matrix related to the rotation angle of the camera is set as R, and an external parameter matrix related to the installation position of the camera is set as T. Then, the matrix of the external parameter matrices R and T is P=(R|T), and an internal parameter matrix for managing the internal state such as the focal length and the optical center of the camera is K.

FIG. 1C illustrates an example of an image coordinates system for identifying a landmark in an image. In this image coordinates system, the u axis is taken in the horizontal direction with the upper left of the image as the origin, and the v axis is taken in the vertical direction. Then, the position of the landmark in the image captured by the camera is specified by (u, v).

Here, assuming that the image coordinates obtained by capturing the transposed matrix X are the transposed matrix u=(u, v, 1)^{T} in the homogeneous coordinate system, the scale parameter is s, and the lens of the perspective projection model is used, Expression (1) is established for each camera. The scale parameter s is a scalar value. Furthermore, a suffix on a symbol in Expression (1) represents the type of camera. Here, in order to identify two cameras, a suffix of one camera is set to “0”, and a suffix of the other camera is set to “1”. Note that, in Expression (1), if there is no scale parameter s, the right side of Expression (1) becomes a constant multiple of the left side. Therefore, a scale parameter s is provided so that the right side of Expression (1) does not become a constant multiple of the left side.

$$[ Math . 1 ]$$

$${s}_{0} {u}_{0} = {K}_{0} {P}_{0} X \qquad ( 1 )$$

$${s}_{1} {u}_{1} = {K}_{1} {P}_{1} X$$

In a case where image coordinates of one camera are given, it is impossible to restore a three-dimensional point of a landmark from the image coordinates without any precondition. However, in a case where there is a set of two cameras showing the same position X, if the same portion of the position X is represented by image coordinates (u₀, u₁), the three-dimensional point X can be estimated by solving the least squares method using Expression (2). However, depending on the form of the formula deformation, it is not necessary to limit to the solution using the Expression (2).

$$[ Math . 2 ]$$

$$( \begin{matrix}{R}_{0} & - {K}_{0}^{- 1} {u}_{0} & 0 \\ {R}_{1} & 0 & - {K}_{1}^{- 1} {u}_{1}\end{matrix} ) ( \begin{matrix}\begin{matrix}X \\ {s}_{0}\end{matrix} \\ {s}_{1}\end{matrix} ) = - ( \begin{matrix}{T}_{0} \\ {T}_{1}\end{matrix} ) \qquad ( 2 )$$

Here, the meaning of Expression (2) will be described with reference to FIG. 1A.

The angle of view of the front camera 10 is an apex angle of a triangle at an installation position of the front camera 10 as illustrated in the imaging range 10a. Similarly, the angle of view of the left camera 20 is an apex angle of a triangle at an installation position of the left camera 20, as illustrated in the imaging range 20a. The angle of view of the right camera 30 is an apex angle of a triangle at an installation position of the right camera 30, as illustrated in the imaging range 30a.

A region where the angle of view of the front camera 10 and the angle of view of the left camera 20 overlap with each other is on the left front side of the vehicle 1. Therefore, the distance can be estimated by the principle of triangulation with respect to the landmark appearing in the region where the angles of view of the two cameras overlap with each other. Similarly, the distance can also be estimated for a region where the angle of view of the front camera 10 and the angle of view of the right camera 30 overlap (right front side of the vehicle 1) by the principle of triangulation.

In order to efficiently search for a landmark commonly appearing in two images at the same position of the two images, the epipole constraint equation shown in Expression (3) is used. In the case that the image coordinates of the landmark in one image is given, the candidate of the position of the image coordinates of the landmark in the other image is on the straight line, so that the condition that the search is performed on the straight line instead of the whole image is provided. The base matrix used in the epipole constraint equation is derived from the external parameter matrix and the internal parameter matrix of the two cameras (for example, front camera 10 and left camera 20) described above.

$$[ Math . 3 ]$$

$${u}_{0} {Fu}_{1} = 0 \qquad ( 3 )$$

Furthermore, if the pre-processing of parallelization is performed by appropriately using the parameter group described above, conversion into an image in which arbitrary points X in the world coordinates are arranged at the same height of the image can be performed. It is possible to search for the same position of the landmark by a simple process of searching in the lateral direction of the parallelized image. This is the principle of a parallel stereo camera. In any case, searching for the same position of the landmark from the two images can be estimated from parameters unique to the camera that captures each image, information on installation conditions, and the like. Here, in FIG. 1A, a combination of images of the front camera 10 and the left camera 20, images of the front camera 10 and the right camera 30, and images of the left camera 20 and the right camera 30 is assumed as both images. In the following, searching the two images to obtain the same position of the landmark is simply referred to as “collation”.

Note that there are several methods for collating image information, and template matching is a typical method. The template matching is a method in which a periphery of image coordinates of a landmark of interest is cut out from one image in a small region such as a rectangle, and a region close to a pixel distribution in the rectangle is searched using an appropriate cost function while moving in the small rectangular region from the other image. As a comparison method, a sum of absolute differences, a sum of square differences, and the like are known as basic methods.

As another method for collating image information, there is a method in which image coordinates in a portion having a high image feature such as a corner of a landmark in an image are first searched to obtain a feature point, and then image feature amounts around the feature point are vectorized (feature amounts) and held. Scale Invariant Feature Transform (SIFT), Oriented FAST and Rotated BRIEF (ORB), and the like are known as representative methods of feature quantization, and deep learning-based methods also exist. The deep learning-based method is a method of collating feature amounts between two images.

Here, an image in which the same landmark appears in an overlapping region of the angles of view of two cameras will be described.

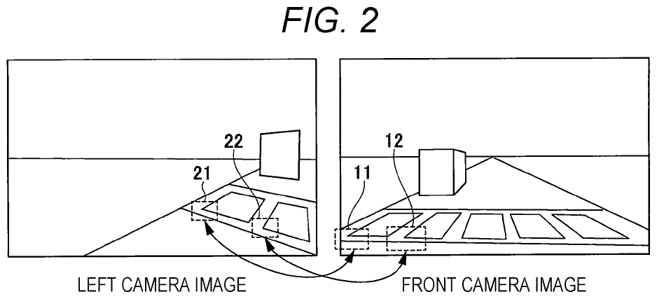

FIG. 2 is a diagram illustrating an example of an image of the foreground of the vehicle 1 captured by the front camera 10 and the left camera 20 illustrated in FIG. 1A. An image captured by the front camera 10 is referred to as a “front camera image”, and an image captured by the left camera 20 is referred to as a “left camera image”.

There is a crosswalk in front of the vehicle 1, and there is a rectangular parallelepiped landmark behind. Both the crosswalk and the landmark on the rectangular parallelepiped are shown in the left camera image and the front camera image. Here, partial regions 21 and 22 of the crosswalk shown in the left camera image are indicated by broken rectangular frames. Similarly, partial regions 11 and 12 of the crosswalk shown in the front camera image are indicated by broken rectangular frames. A place corresponding to the rectangular frame of the left camera image such as a combination of the regions 21 and 11 and a combination of the regions 22 and 12 also exists in the front camera image. However, the appearance of the inside of the rectangular frame (part of the crosswalk) is greatly different between the left camera image and the front camera image.

It is difficult to collate images of the same place shown in two images that are largely different in appearance as described above by the template matching described above, and it is also difficult to collate images using feature points or feature amounts. Usually, in template matching, pixels at the same position in an image are compared with each other, but if the appearance is different, matching becomes difficult. Furthermore, even if feature points or feature amounts are created between images having different appearances, it is difficult to match the images with each other. Therefore, different shapes are collated with each other, or a shape that should be originally determined to be the same is not found in the image and is not collated. If matching of the same landmark appearing in different images is not correctly performed, the distance to the landmark may be erroneously estimated.

Therefore, the inventor of the present invention have studied how to transform one image to reduce the difference between the landmark at the time of collation between two images largely different in appearance. Hereinafter, an external world recognition device and a landmark collation method according to each embodiment of the present invention capable of improving the performance of collation of the same object shown in two images will be described with reference to FIG. 3 and subsequent drawings. The function of the external world recognition device is realized by software configured in an ECU mounted on the vehicle 1.

FIG. 3 is a block diagram illustrating an internal configuration example of the external world recognition device 100 according to the first embodiment. The external world recognition device 100 is, for example, a form of an ECU mounted on the vehicle 1. Furthermore, in the following description, the vehicle 1 on which the external world recognition device 100 is mounted is also referred to as “own vehicle 1” in order to be distinguished from another vehicle 2.

The external world recognition device 100 is a device mounted on the vehicle 1. The external world is, for example, the outside of the vehicle 1 on which the external world recognition device 100 is mounted, and the external world recognition device 100 recognizes various landmarks existing in the external world. The recognition result of the landmark includes, for example, information such as an attribute of the landmark, a size of the landmark, and a distance from the vehicle 1 to the landmark.

Two images captured by the two imaging units 40 and 41 are input to the external world recognition device 100. The imaging unit 40 is, for example, the left camera 20 illustrated in FIG. 1A, and outputs an image 40a captured by the left camera 20 to a landmark detection unit 101.

The imaging unit 41 is, for example, front camera 10 illustrated in FIG. 1A, and outputs an image 41a captured by the front camera 10 to a landmark detection unit 102.

The combination of the cameras illustrated in FIG. 1A of the imaging units 40 and 41 may be the front camera 10 and the right camera 30, and the left camera 20 and the right camera 30.

The external world recognition device 100 includes two landmark detection units 101 and 102, a camera parameter 103, a collation condition determination unit 104, a feature collation unit 105, and a position estimation unit 106.

The landmark detection unit 101 performs landmark detection processing on the image input from the imaging unit 40. A first landmark detection unit (landmark detection unit 101) detects a landmark on the basis of a first image (image 40a) acquired from at least a first imaging unit (imaging unit 40) among a plurality of imaging units in which at least a part of an imaging visual field with respect to the external world overlaps.

The landmark detection unit 102 performs the landmark detection processing on the image input from the imaging unit 41. A second landmark detection unit (landmark detection unit 102) detects a landmark on the basis of a second image (image 41a) acquired from a second imaging unit (imaging unit 41) among the plurality of imaging units.

The landmark detection processing performed by the landmark detection units 101 and 102 is, for example, a process of detecting the vehicle 2, a white line, a pedestrian, a travelable region of the vehicle 1, a guardrail, a side wall, and the like from the input images 40a and 41a. A part of each image shown in the regions 11, 12, 21, and 22 as illustrated in FIG. 2 is output to a subsequent functional unit as a result of the landmark detection processing. Note that landmark detection units 101 and 102 can also obtain an attribute of a landmark by performing image analysis for each landmark through landmark detection processing. A result of the landmark detection processing by the landmark detection unit 101 is output to an imaging plane estimation unit 111 of the collation condition determination unit 104. A result of the landmark detection processing by the landmark detection unit 102 is output to the feature collation unit 105. In the following description, a result of the landmark detection processing is also referred to as a “detection result of the landmark”.

Furthermore, the image captured by the imaging unit 40 is input to the collation condition determination unit 104 via the landmark detection unit 101, and further input to the feature collation unit 105 via the collation condition determination unit 104. The image captured by the imaging unit 41 is input to the feature collation unit 105 via the landmark detection unit 102.

The collation condition determination unit 104 determines a collation condition for the feature collation unit 105 to collate positions at which the same landmark detected in the images 40a and 41a corresponds to each other. The collation condition determination unit 104 includes an imaging plane estimation unit 111 and a geometric transform estimation unit 112.

The imaging plane estimation unit (imaging plane estimation unit 111) estimates the imaging plane in the first image (image 40a) on the basis of the detection result of the landmark by the landmark detection unit (landmark detection unit 101). The imaging plane estimation unit 111 estimates a plane of each landmark in the real world on the basis of the detection result of the landmark input from the landmark detection unit 101. A plane constituting each landmark is referred to as an imaging plane, and is expressed by a plane equation of the imaging plane. The imaging plane estimation unit (imaging plane estimation unit 111) estimates the imaging plane on the basis of the size of the landmark and the distance to the landmark. Furthermore, the imaging plane estimation unit (imaging plane estimation unit 111) estimates the imaging plane in the image region in which the landmark is imaged. Note that the plane equation is represented by, for example, a parameter (α, β, γ, δ). The equation of the imaging plane estimated by the imaging plane estimation unit 111 is output to the geometric transform estimation unit 112.

The image transform estimation unit (geometric transform estimation unit 112) estimates an image transform parameter (geometric transform parameter) matching the imaging plane of the second image (image 41a) among the plurality of imaging units on the basis of the information of the imaging plane estimated by the imaging plane estimation unit (imaging plane estimation unit 111) and the imaging parameters (camera parameters 103) of the plurality of imaging units. For example, the geometric transform estimation unit 112 estimates a geometric transform parameter between images at places imaged by the imaging units 40 and 41 on the basis of the equation of the imaging plane input from the imaging plane estimation unit 111 and the camera parameter 103. Examples of the camera parameter 103 include K and P included in the above-described Expression (1). However, the camera parameter 103 may be a fixed value.

Note that the imaging plane estimation unit 111 and the geometric transform estimation unit 112 may be on the landmark detection unit 102 side.

The feature collation unit (feature collation unit 105) collates the feature of the landmark detected from the first image (image 40a) subjected to the image transform using the image transform parameter (geometric transform parameter) by the image transform estimation unit (geometric transform estimation unit 112) with the feature of the landmark detected from the second image (image 41a). The feature collation unit 105 collates a feature of a transform result obtained by performing geometric transform on the landmark detected by the landmark detection unit 101 with a feature of the detection result of the landmark input from the landmark detection unit 102. Therefore, the feature collation unit 105 converts the shape of the landmark detected from the image 40a using the geometric transform parameters estimated by the geometric transform estimation unit 112. Thereafter, the feature collation unit 105 collates the shape of the landmark whose shape has been converted with the shape of the landmark detected from the image 41a, and calculates the distance from the own vehicle 1 to the landmark. The distance from the own vehicle 1 to the landmark is output to the position estimation unit 106 as a collation result by the feature collation unit 105. For example, the collation result may be represented by a value in which a mismatch is 0% and an exact match is 100% for each image region including the landmark to be collated. Then, when the comparison result is 80% or more, the feature collation unit 105 may determine that the collation result has high reliability and output the collation result having high reliability to the position estimation unit 106.

The position estimation unit (position estimation unit 106) estimates the three-dimensional position of the landmark on the basis of the result of the collation processing by the feature collation unit (feature collation unit 105). For example, the position estimation unit 106 estimates a three-dimensional position (referred to as a “position estimation result”) of the landmark in the world coordinate system (see FIG. 1B) on the basis of a collation result by the feature collation unit 105. At this time, the position estimation unit 106 can calculate the distance from the own vehicle 1 to the landmark and include the distance for each landmark in the position estimation result. The position estimation result is used for vehicle control of the own vehicle 1 by another ECU (for example, an ECU for automatic driving control) mounted on the own vehicle 1, or used for obtaining depth information of a landmark around the own vehicle 1.

Next, a hardware configuration of a computer 80 constituting the external world recognition device 100 will be described.

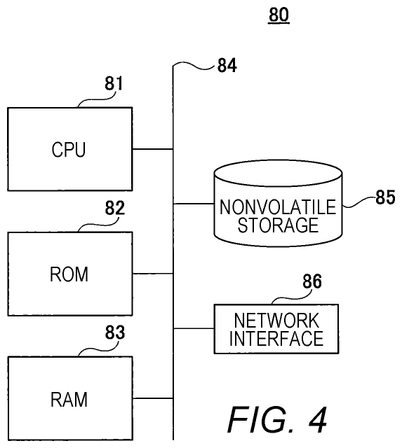

FIG. 4 is a block diagram illustrating a hardware configuration example of the computer 80. The computer 80 is an example of hardware used as a computer operable as the external world recognition device 100 according to the present embodiment. The external world recognition device 100 according to the present embodiment realizes an image processing method performed by the respective functional blocks illustrated in FIG. 3 in cooperation with each other by the computer 80 (computer) executing a program.

The computer 80 includes a central processing unit (CPU) 81, a read only memory (ROM) 82, and a random access memory (RAM) 83, each of which is connected to a bus 84. Moreover, the computer 80 includes a nonvolatile storage 85 and a network interface 86.

The CPU 81 reads a program code of software for realizing each function according to the present embodiment from the ROM 82, loads the program code into the RAM 83, and executes the program code. Variables, parameters, and the like generated during arithmetic processing of the CPU 81 are temporarily written to the RAM 83, and these variables, parameters, and the like are appropriately read by the CPU 81. However, a micro processing unit (MPU) may be used instead of the CPU 81. The function of each functional unit in the external world recognition device 100 is realized by the CPU 81, the ROM 82, and the RAM 83.

As the nonvolatile storage 85, for example, a hard disk drive (HDD), a solid state drive (SSD), a flexible disk, an optical disk, a magneto-optical disk, a CD-ROM, a CD-R, a magnetic tape, or a nonvolatile memory may be used. In addition to an operating system (OS) and various parameters, a program for causing the computer 80 to function is recorded in the nonvolatile storage 85. The ROM 82 and the nonvolatile storage 85 record programs, data, and the like necessary for the operation of the CPU 81, and are used as an example of a computer-readable non-transitory storage medium storing a program executed by the computer 80. Various values such as the camera parameter 103 are stored in the RAM 83 or the nonvolatile storage 85 and read as appropriate.

A network interface card (NIC) or the like is used as the network interface 86, for example, and various data can be transmitted and received to and from external devices via a local area network (LAN), a dedicated line, or the like connected to a terminal of the NIC.

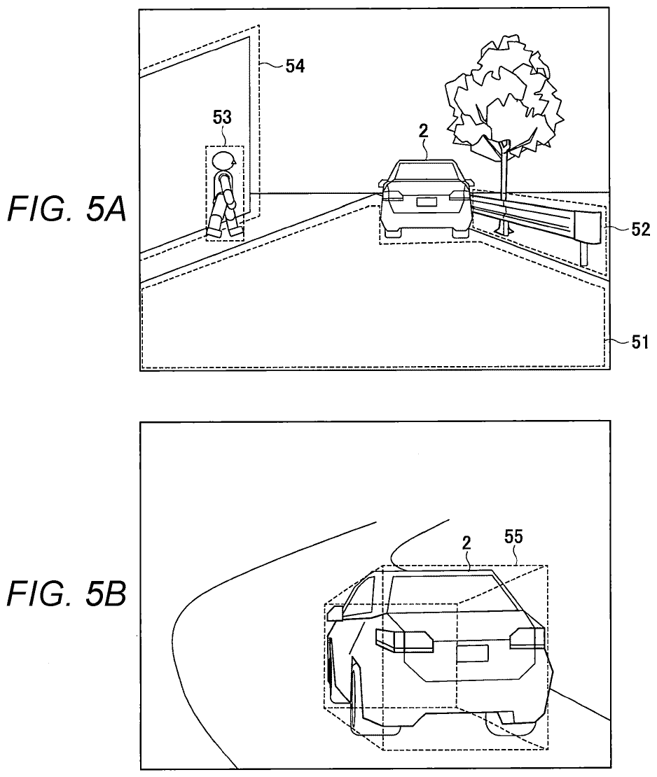

Here, processing performed by the imaging plane estimation unit 111 will be described with reference to FIGS. 5A and 5B.

FIGS. 5A and 5B illustrate examples of images captured by the front camera 10.

FIG. 5A is an image showing another vehicle 2, a person, a guardrail, and a side wall in a straight traveling direction. In FIG. 5A, a region 51 represents a detection result of a road surface, a region 52 represents a detection result of a guardrail, a region 53 represents a detection result of a person, and a region 54 represents a detection result of a side wall. In this manner, the regions 51 to 54 are used as a detection result of the landmark.

The imaging plane estimation unit 111 estimates parameters (α, β, γ, δ) such that, for example, the imaging plane follows αX+βY+γZ+δ=0, which is a plane equation, in accordance with a detection result at certain image coordinates.

For example, it is assumed that a result of landmark detection unit 101 detecting a landmark from an image is a road surface such as the region 51. In this case, the imaging plane estimation unit 111 estimates a plane captured at the image coordinates as a vehicle contact surface on which the vehicle 1 is traveling in contact, Z=0, that is, (α, β, γ, δ)=(0, 0, 1, 0). Note that, in a case where the detection result of the landmark is a slope, the plane equation is expressed as, for example, hX+Z+k=0. That is, the imaging plane estimation unit 111 can estimate as (α, β, γ, δ)=(h, 0, 1, k).

FIG. 5B is an image showing another vehicle 2 obliquely in front of the own vehicle 1. Here, a scene where there is a curved road in front of the own vehicle 1 is assumed. For example, it is assumed that the detection result by the landmark detection unit 101 is another vehicle 2, and the detection result is output as a rectangular parallelepiped bounding box like the region 55. In this case, the imaging plane estimation unit 111 estimates a plane equation of each surface with the front surface, the back surface, and the side surface of the rectangular parallelepiped as imaging planes from the shape of the rectangular parallelepiped represented by the region 55. Note that the front surface of the bounding box in the region 55 is the surface on the front side of the vehicle 2, the back surface is the surface on the back side of the vehicle 2, and the side surface is the surfaces on the left and right of the vehicle 2.

Here, it is assumed that another vehicle 2 detected by the landmark detection unit 101 stands upright on a plane of Z=0. Therefore, in the imaging plane estimation unit 111, the plane equation of the rectangular parallelepiped surface represented by the region 55 is expressed as, for example, aX+bY+d=0. That is, the imaging plane estimation unit 111 estimates the parameters of the plane equation as (α, β, γ, δ)=(a, b, 0, d). In the present specification, estimating the parameter of the plane equation is also referred to as “estimating the imaging plane”.

However, the actual coefficient value varies depending on the surface of the rectangular parallelepiped. As the actual coefficient value, an estimated distance from the own vehicle 1 to another vehicle 2 output from a sensor is used. For example, by using a known measurement principle capable of estimating the distance from the positions of the road surface and the ground contact surface of another vehicle 2 and the installation position and the installation angle of the monocular camera, the detection result may include estimation information of the distance. In this case, the imaging plane estimation unit 111 can also estimate a plane equation of the side surface of the vehicle 1 or the like on the basis of the estimation information of the distance included in the detection result. Therefore, the imaging plane estimation unit 111 can also output the estimated plane equation as an estimation result.

Furthermore, for example, a case where the detection result is a pedestrian or an obstacle is assumed. In this case, the imaging plane estimation unit 111 cannot clearly estimate the imaging plane only by outputting a rectangular bounding box as a detection result as illustrated in the regions 52 and 53 in FIG. 5A. Therefore, the imaging plane estimation unit 111 assumes that, for example, a plane perpendicular to the traveling direction of the own vehicle 1 is formed. Then, the imaging plane estimation unit 111 expresses the plane equation as X+e=0. That is, the imaging plane estimation unit 111 can estimate the parameters of the plane equation as (α, β, γ, δ)=(1, 0, 0, e). In addition, when a rectangular parallelepiped bounding box is output as a detection result for the region 52 in which the guardrail is shown and the region 54 in which the side wall is shown in FIG. 5A, the imaging plane estimation unit 111 can estimate a plane equation of an imaging plane corresponding to a side surface of the rectangular parallelepiped. Note that the imaging plane estimation unit 111 may estimate the parameters (α, β, γ, δ) of the plane equation for each object on the assumption that the object perpendicularly faces the arrival direction of the light beam to each camera or the optical axis of each camera.

By the way, there may be a case where an attribute is not given to a three-dimensional object such as a pole or a tree, and there is a region where the attribute of the detection result is unknown. In this case, the imaging plane estimation unit 111 assumes a three-dimensional object having a predetermined height at the position of a pole or a tree, and assumes that a plane perpendicular to the traveling direction of the vehicle 1 is formed. Then, the imaging plane estimation unit 111 can estimate the parameters of the plane equation assuming a rectangular bounding box in a region where the attribute of the detection result is unknown as if the detection result is a pedestrian.

Note that, as another example of the method of estimating the imaging plane by the imaging plane estimation unit 111, it is also conceivable to use a quadratic equation or a multi-order equation instead of a simple linear equation with respect to the detection result of the landmark. In that case, the imaging plane estimation unit 111 divides and approximates the multi-order equation into piecewise linear equations according to the position of interest on the image, and estimates the imaging plane. As described above, the imaging plane estimation unit 111 estimates the imaging plane of the landmark on the basis of the detection result of the landmark.

Next, a method by which the geometric transform estimation unit 112 estimates a geometric transform parameter will be described.

The geometric transform estimation unit 112 estimates the geometric transform parameters of the two images 40a and 41a captured by the two cameras (the imaging units 40 and 41) on the basis of the estimation result of the imaging plane estimated by the imaging plane estimation unit 111 and the camera parameters 103. An example of a method of estimating the geometric transform parameter will be described.

First, the estimation result of the imaging plane estimation unit 111 processed for one image (the image 40a captured by the imaging unit 40) is used. In a case where a certain pixel coordinate in the image captured by the imaging unit 40 is focused on, the geometric transform estimation unit 112 transforms a plane equation for the pixel coordinate into a plane transform matrix. For example, the geometric transform estimation unit 112 organizes the plane equation for Z and introduces a plane transform matrix C as shown in Expression (4). Then, the four-dimensional world coordinates (homogeneous coordinates) X are one-dimensionally compressed and organized as X′.

$$[ Math . 4 ]$$

$$X = ( \begin{matrix}1 & 0 & 0 \\ 0 & 1 & 0 \\ - \frac{α}{γ} & - \frac{β}{γ} & - \frac{δ}{γ} \\ 0 & 0 & 1\end{matrix} ) ( \begin{matrix}\begin{matrix}X \\ Y\end{matrix} \\ 1\end{matrix} ) = {CX}^{′} \qquad ( 4 )$$

The geometric transform estimation unit 112 can convert s₀u₀ and s₁u₁ expressed in Expression (1) into Expressions (5) and (6) by using X′. The geometric transform estimation unit 112 can derive a projective transform matrix H (geometric transform parameter) as in Expression (7) by organizing Expression (5) and Expression (6) simultaneously. Note that the camera parameters 103 input to the collation condition determination unit 104 are used in Expressions (5) to (7) since there are K and P included in Expression (1). Expression (7) expresses the relative relationship between the two images 40a and 41a.

$$[ Math . 5 ]$$

$${s}_{0} {u}_{0} = {K}_{0} {P}_{0} X = {K}_{0} {P}_{0} {CX}^{′} \qquad ( 5 )$$

$${s}_{1} {u}_{1} = {K}_{1} {P}_{1} X = {K}_{1} {P}_{1} {CX}^{′} \qquad ( 6 )$$

$${su}_{0} = {K}_{0} {P}_{0} {{C}_{0} ( {P}_{1} {C}_{1} )}^{- 1} {K}_{1}^{- 1} {u}_{1} = {Hu}_{1} \qquad ( 7 )$$

Note that the geometric transform estimation unit 112 may perform the geometric transform with affine transform, shear transform, or the like having a smaller number of transform parameters than the projective transform in some cases, depending on the parallelization processing described above, the installation position of the camera, and the plane equation. If the number of transform parameters used for the geometric transform by the geometric transform estimation unit 112 is small, the calculation time by the geometric transform estimation unit 112 is shortened. Therefore, the geometric transform estimation unit 112 may switch the transform type according to the number of transform parameters. In the following processing, various types of transform processing are collectively referred to as “geometric transform” as an example of image transform.

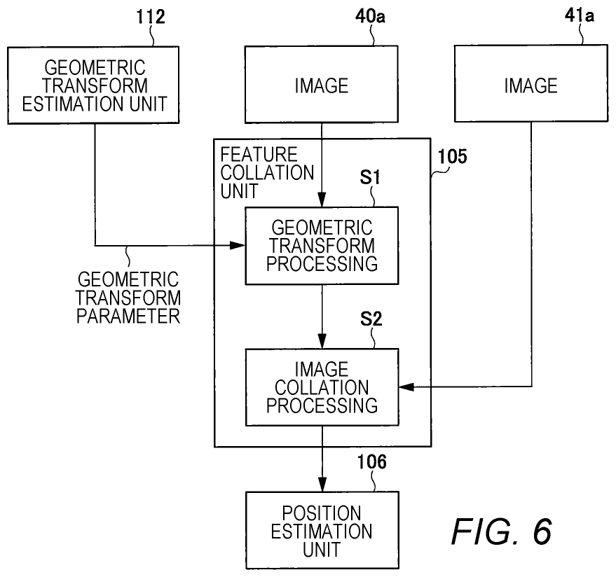

The feature collation unit 105 collates the images using the estimation result by the geometric transform estimation unit 112 and the images captured by the imaging units 40 and 41. An example of processing in which the feature collation unit 105 collates two images will be described with reference to FIG. 6.

FIG. 6 is a diagram illustrating an example of processing of the feature collation unit 105. The images 40a and 41a are input to the feature collation unit 105 from the imaging units 40 and 41 illustrated in FIG. 3.

The geometric transform parameter is used as an estimation result of the geometric transform estimation unit 112 for an arbitrary point in the image 40a. The geometric transform parameter is expressed as the projective transform matrix H of the above-described expression (7). In the feature collation unit 105, the image 40a captured by the imaging unit 40 and the geometric transform parameters estimated by the geometric transform estimation unit 112 are input, and the geometric transform processing is performed on the place of the image 40a (S1).

Furthermore, the image 41a captured by the imaging unit 41 is input to the feature collation unit 105 via the landmark detection unit 102. Then, the feature collation unit 105 performs image collation processing between the image 40a subjected to the geometric transform processing in step S1 and the other image 41a input via the landmark detection unit 102 (S2). However, the place to be geometrically transformed is a region around the position including the position where the same part of the landmark is detected in the images 40a and 41a.

In the image collation processing, template matching between the geometrically transformed portion of the image 40a and the corresponding portion of the image 41a, extraction processing of feature points of the image, and extraction processing of feature amounts are performed. In the case of the projective transform, since the geometric transform itself includes a movement component, the collation point is equivalent to being estimated to some extent around the position given by the geometric transform. Therefore, the feature collation unit 105 may search around the position given by the geometric transform. After step S2, the processing result is output to the position estimation unit 106.

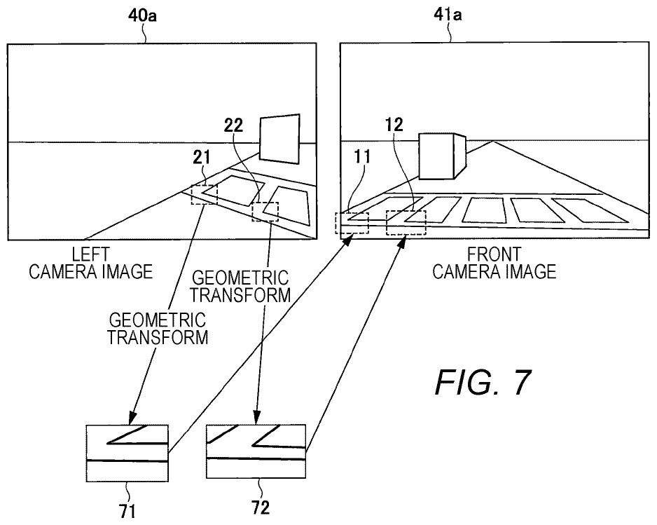

Here, an example of template matching will be described with reference to FIG. 7.

FIG. 7 is a diagram illustrating how the feature collation unit 105 performs template matching using the left camera image and the front camera image. Here, it is assumed that the left camera image is the image 40a illustrated in FIG. 7 and the front camera image is the image 41a illustrated in FIG. 7.

As illustrated in FIG. 2, there are regions 21 and 22 in which feature portions of intersections (portions where white lines intersect) appear in a part of the left camera image and the front camera image. This feature portion also exists in the front camera image as regions 11 and 12, respectively. However, since the shapes of the regions 21 and 11 are different and the shapes of the regions 22 and 12 are also different, the shapes of the respective regions cannot be simply matched by the conventional method.

On the other hand, by using the projective transform (geometric transform) according to the present embodiment, the landmarks in the regions 21 and 22 included in the left camera image are transformed into the shapes of regions 71 and 72 illustrated on the lower side of FIG. 7. At this time, the shapes included in the regions 71 and 72 are close to the shapes included in the regions 11 and 12, respectively. Therefore, the feature collation unit 105 can perform the collation processing more easily than searching the shape before the geometric transform included in the regions 21 and 22 from the front camera image. When the shape of the region including the feature portion is geometrically transformed in this manner, an effect that the feature collation unit 105 can easily perform the collation processing can be obtained.

Note that, in a case where the plane equation is constant in a certain image region, the feature collation unit 105 may perform the template matching after projective transform of the region. Alternatively, the feature collation unit 105 may perform the projective transform for each template.

Furthermore, the process of extracting a feature point in an image and the process of extracting a feature amount (referred to as “extraction of a feature point and a feature amount”) are similar. The feature collation unit 105 may once perform projective transform on the image and then extract a feature point and a feature amount. Alternatively, the feature collation unit 105 may incorporate projective transform in the process of extracting the feature point and the feature amount to extract the feature point and the feature amount.

The position estimation unit 106 calculates the coordinate point of the landmark in the world coordinate system from the obtained corresponding position as a result of the collation by feature collation unit 105 using the above Expression (2).

With the above-described configuration, the external world recognition device 100 can improve the collation accuracy of the landmark appearing in the two images and the estimation accuracy of the distance from the vehicle 1 to the landmark while coping with environmental changes such as the vehicle 1, a pedestrian, and a road, during traveling of the vehicle 1.

In the external world recognition device 100 according to the first embodiment described above, in order to estimate the distance from the own vehicle 1 to the landmark, the plane equation of the imaging plane corresponding to the position in the image 40a is estimated for each landmark in accordance with the travel environment dynamically changing with the travel of the vehicle. Then, the external world recognition device 100 performs geometric transform for each landmark to collate the landmark detected from the image 41a with the feature. Therefore, even in a case where an unspecified landmark appears in two images having different appearances, the external world recognition device 100 can estimate the distance to the landmark. Furthermore, the position estimation unit 106 estimates the position of the landmark of which the feature is collated, so that the error in the distance to the landmark can be reduced.

### Second Embodiment

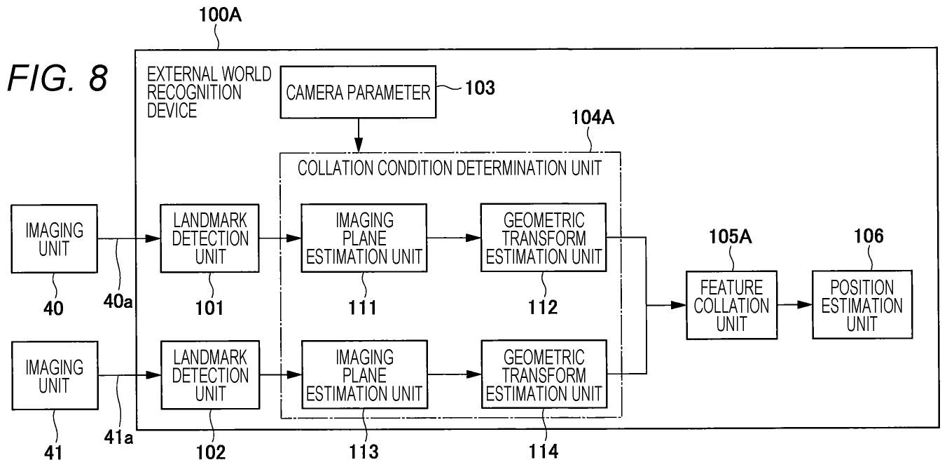

Next, a configuration example and a processing example of an external world recognition device 100A according to a second embodiment of the present invention will be described with reference to FIG. 8.

FIG. 8 is a block diagram illustrating an internal configuration example of an external world recognition device 100A according to the second embodiment.

The external world recognition device 100A includes landmark detection units 101 and 102, a camera parameter 103, a collation condition determination unit 104A, a feature collation unit 105A, and a position estimation unit 106. The external world recognition device 100A performs imaging plane estimation processing and geometric transform parameter estimation on each of the two images input from the imaging units 40 and 41. Therefore, the external world recognition device 100A includes a plurality of imaging plane estimation units (imaging plane estimation units 111 and 113) and a plurality of image transform estimation units (geometric transform estimation units 112 and 114) respectively provided for a landmark detected from the first image (image 40a) and a landmark detected from the second image (image 41a). As illustrated in FIG. 8, the collation condition determination unit 104A included in the external world recognition device 100A includes the imaging plane estimation units 111 and 113 and the geometric transform estimation units 112 and 114. The imaging plane estimation units 111 and 113 have the same function, and the geometric transform estimation units 112 and 114 have the same function.

The landmark detection unit 101 detects a landmark from an image captured by the imaging unit 40. For this detection result, the imaging plane estimation unit 111 estimates the imaging plane, and the geometric transform estimation unit 112 estimates the geometric transform parameters.

Similarly, landmark detection unit 102 detects a landmark from an image captured by the imaging unit 41. With respect to the detection result of the landmark, the imaging plane estimation unit 113 estimates the imaging plane, and the geometric transform estimation unit 114 estimates the geometric transform parameter.

The feature collation unit 105A receives two results through the geometric transform estimation units 112 and 114. Therefore, the function of the feature collation unit 105A is different from the function of the feature collation unit 105 according to the first embodiment illustrated in FIG. 3.

Several methods are assumed for implementing the function of the feature collation unit 105A. In the one method, the feature collation unit 105A obtains a collation result between a result of the geometric transform of the image 40a using the geometric transform parameter estimated by the one geometric transform estimation unit 112 and the image 41a. Furthermore, the feature collation unit 105A obtains a result of the geometric transform of the image 41a using the geometric transform parameter estimated by the other geometric transform estimation unit 114 and a collation result with the image 40a. Then, the two collation results obtained by the feature collation unit 105A are compared. In a case where it is found that the same landmark is collated at the same place from the two collation results, both of the collation results can be regarded as having high reliability.

Therefore, the feature collation unit (the feature collation unit 105A) acquires a collation result between a result of image transform (geometric transform) of the first image (the image 40a) by using the image transform parameter (geometric transform parameter) estimated by one image transform estimation unit (the geometric transform estimation unit 112) and the second image (the image 41a), acquires a collation result between a result of geometric transform of the second image (the image 41a) by using the image transform parameter (geometric transform parameter) estimated by the other image transform estimation unit (the geometric transform estimation unit 114) and the first image (the image 40a), compares the respective collation results, and in a case where the landmark detected from the first image (the image 40a) and the landmark detected from the second image (the image 41a) are collated at the same three-dimensional position, gives high reliability to the collation result. The reliability given to the collation result here may be represented by a value in which, for each landmark detected from each image, mismatch is set to 0% when collation is not performed at the same three-dimensional position, and mismatch is set to 100% when collation is performed at the same three-dimensional position. Then, the feature collation unit 105 may output a collation result with high reliability to the position estimation unit 106 as long as the reliability is 80% or more.

Furthermore, the feature collation unit 105A may collate the estimated imaging plane. Therefore, the feature collation unit 105A compares the imaging plane estimated by the imaging plane estimation unit 111 with the imaging plane estimated by the imaging plane estimation unit 113. At this time, in a case where the imaging plane estimated by the imaging plane estimation unit 113 is used as a reference and the imaging planes estimated by the imaging plane estimation unit 111 are different, the feature collation unit 105A determines that there is a collation mistake because the reliability of the collation result is low. Then, the feature collation unit 105A can cope with not outputting a feature collation result to the position estimation unit 106 with respect to a landmark that is the target of the estimated imaging plane. As described above, the feature collation unit 105A outputs the collation result to the position estimation unit 106 while leaving only the collation result with high reliability, or determines the collation result with low reliability as noise and does not output the collation result. For this reason, the position estimation unit 106 can estimate the position and the distance of the landmark only by limiting to the landmark having the high reliability of the collation result.

In the external world recognition device 100A according to the second embodiment described above, the collation condition determination unit 104A includes the imaging plane estimation units 111 and 113 and the geometric transform estimation units 112 and 114. Then, the feature collation unit 105A can obtain the reliability of the collation result by collating the estimation result with one of the estimation results output from the geometric transform estimation units 112 and 114 as a reference. Therefore, it is easy to determine whether the landmark has been correctly collated on the basis of the level of reliability of the collation result by the feature collation unit 105A, and the position estimation unit 106 can also accurately estimate the position of the landmark.

### Third Embodiment

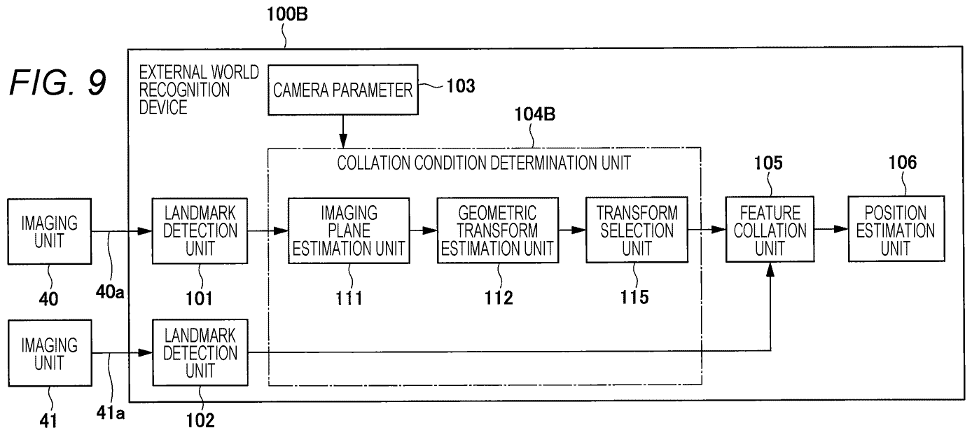

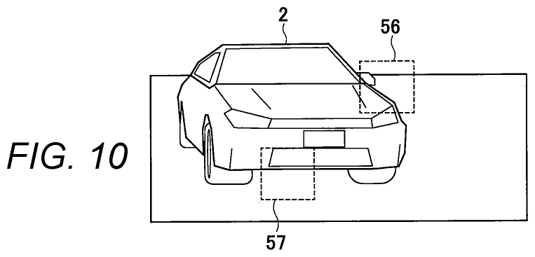

Next, a configuration example and a processing example of an external world recognition device 100B according to a third embodiment of the present invention will be described with reference to FIGS. 9 and 10.

In a case where landmarks having a plurality of attributes are mixed in the image region designated by the landmark detection unit 101, several methods can be considered in order that a collation condition determination unit 104B illustrated in FIG. 9 accurately detects the landmark having each attribute. For example, when receiving the detection result of the landmark detected by the landmark detection unit 101, the collation condition determination unit 104B may preferentially measure the landmark that is the foreground of the landmark to be collated from the attribute of the landmark detected by the landmark detection unit 101 and the plane equation estimated by the imaging plane estimation unit 111.

Furthermore, in a case where a plurality of attributes are detected for each landmark by the landmark detection unit 101, the collation condition determination unit 104B may employ a method of selecting an attribute of a dominant landmark. The dominant landmark is, for example, a landmark that becomes the foreground when a plurality of landmarks appear in an image region. In this case, the feature collation unit 105 collates the feature of the landmark according to the attribute of the dominant landmark that is the foreground with respect to the dominant landmark, and estimates the position of the landmark. Here, the collation condition determination unit 104B included in the external world recognition device 100B capable of selecting a dominant landmark among a plurality of landmarks detected from the images 40a and 41a will be described.

FIG. 9 is a block diagram illustrating an internal configuration example of the external world recognition device 100B according to the third embodiment. In the external world recognition device 100B according to the third embodiment, in a case where landmarks having a plurality of attributes are mixed in the image region designated by the landmark detection unit 101, a process of selecting a specific landmark as a template matching target by the feature collation unit 105 is performed.

The external world recognition device 100B includes the landmark detection units 101 and 102, a camera parameter 103, a collation condition determination unit 104B, a feature collation unit 105, and a position estimation unit 106. The collation condition determination unit 104B included in the external world recognition device 100B includes a transform selection unit 115 in addition to the imaging plane estimation unit 111 and the geometric transform estimation unit 112.

The transform selection unit (transform selection unit 115) selects a landmark at a close distance from among a plurality of landmarks detected from the first image (image 40a) and the second image (image 41a), and selects an image transform parameter (geometric transform parameter) estimated by the image transform estimation unit (geometric transform estimation unit 112) for the selected landmark. For example, the transform selection unit 115 selects a geometric transform parameter estimated for a landmark having a dominant attribute from among the geometric transform parameters for a plurality of landmarks estimated by the geometric transform estimation unit 112. Then, the geometric transform parameter selected by the transform selection unit 115 is output to the feature collation unit 105.

The feature collation unit (feature collation unit 105) performs image transform of the landmark detected from the first image (image 40a) by using the image transform parameter (geometric transform parameter) selected by the transform selection unit (transform selection unit 115). Then, the feature collation unit 105 collates the feature of the landmark after the geometric transform with the feature of the landmark detected by the landmark detection unit 102, and outputs a collation result to the position estimation unit 106.

Here, a specific example of the processing performed by the collation condition determination unit 104B illustrated in FIG. 9 will be described with reference to FIG. 10. Here, as an example, an example will be described in which the collation condition determination unit 104B selects an attribute of a landmark close to, that is, in front of the own vehicle 1 using a plane equation.

FIG. 10 is a diagram illustrating an example of regions 56 and 57 in which the vehicle 2 and the background are mixed. It is assumed that the vehicle 2 is traveling while facing the own vehicle 1.

In the region 56, a part of the left side of the vehicle 2 and the road surface as the background are mixed. Furthermore, in the region 57, a part of the lower side of the vehicle 2 and the road surface as the background are mixed. Normally, in a case where the road surface is included on the upper side of the image, the three-dimensional object is on the front side of the road surface. In a case where the frame to be subjected to template matching by the feature collation unit 105 is the region 56, the shape of the vehicle 2 in front of the background is preferentially adopted as a matching target.

On the other hand, in a case where the image includes the three-dimensional object and the road surface, the road surface on the lower side of the image is closer than the three-dimensional object. In a case where the frame to be subjected to template matching by the feature collation unit 105 is the region 57, since the junction between the lower part of the vehicle 2 and the road surface is closer to the own vehicle, the shape of the road surface in front of the own vehicle 1 is preferentially adopted as a matching target.

As another example, from the viewpoint of vehicle control, a three-dimensional object (for example, the vehicle 2) having a large influence on traveling in a case where the own vehicle 1 comes in contact may be prioritized, and may be simply determined as a matching target from attribute information for each vehicle. In this case, the transform selection unit (transform selection unit 115) preferentially selects a landmark having an attribute that greatly affects traveling of the own vehicle. As a result, since the distance to the landmark having an attribute that greatly affects the traveling of the own vehicle is preferentially estimated by the position estimation unit 106, the own vehicle can perform control such as avoiding the landmark for which the distance has been estimated.

In the external world recognition device 100B according to the third embodiment described above, in a case where a landmark having a plurality of attributes is detected in one image region in the image 40a, it is possible to select a geometric transform parameter for the one landmark, perform the geometric transform of the landmark, and collate the landmark with the landmark in the corresponding image region of the image 41a. Therefore, in the feature collation unit 105, the landmarks to be collated in the images 40a and 41a are likely to match, and in the position estimation unit 106, the position estimation of the collated landmark can also be accurately performed.

### Fourth Embodiment

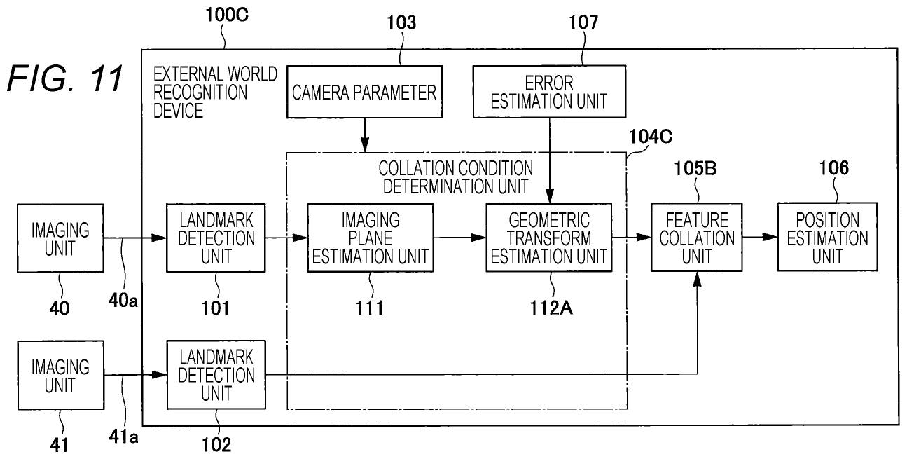

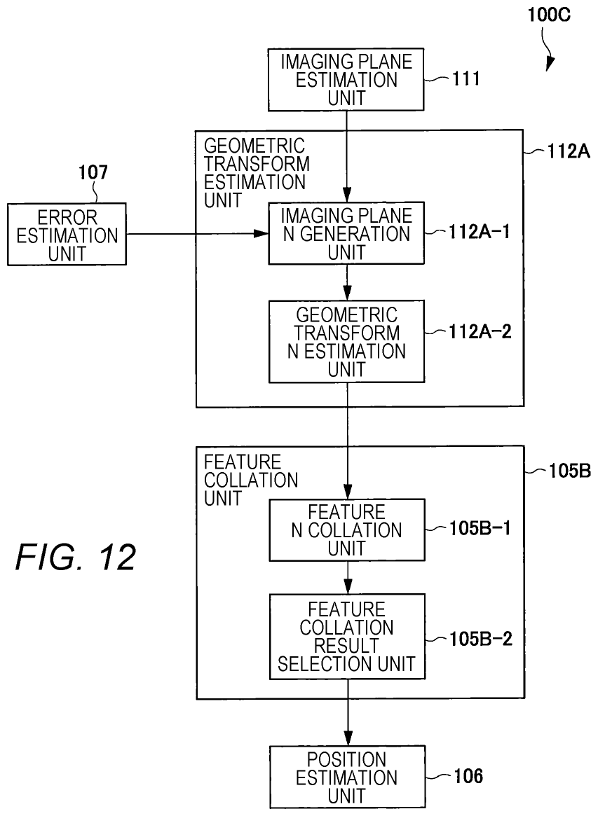

Next, a configuration example and a processing example of an external world recognition device 100C according to a fourth embodiment of the present invention will be described with reference to FIGS. 11 and 12.

The model of the road surface (plane equation) estimated by the imaging plane estimation unit 111 is expected to deviate from the actual plane model as the landmark is farther from the own vehicle 1. That is, the plane equation itself estimated by the imaging plane estimation unit 111 on the basis of the detection result of the landmark detection unit 101 may include an error. Therefore, it is assumed that the error included in the plane equation may affect the accuracy of the feature collation by a feature collation unit 105B. Here, a configuration example of an external world recognition device 100C in which the error included in the plane equation does not affect the accuracy of the feature collation by the feature collation unit 105B will be described.

FIG. 11 is a block diagram illustrating an internal configuration example of the external world recognition device 100C according to the fourth embodiment. In the external world recognition device 100C according to the fourth embodiment, in a case where the plane equation includes an error, a process of collating the features of the landmark is performed.

The external world recognition device 100C has the same configuration as the external world recognition device 100 illustrated in FIG. 3, but is different in that the collation condition determination unit 104 is replaced with a collation condition determination unit 104C, and an error estimation unit 107 connected to a geometric transform estimation unit 112A of the collation condition determination unit 104C is provided.

The error estimation unit (error estimation unit 107) estimates an error of the imaging plane estimated by the imaging plane estimation unit (imaging plane estimation unit 111). For example, the error estimation unit 107 estimates an error of the plane equation estimated by the imaging plane estimation unit 111 and outputs an estimation result to the geometric transform estimation unit 112A. The error of the plane equation is, for example, a value determined in an experiment or a design stage performed in advance. As an estimation result of the error by the error estimation unit 107, a method of increasing the output of the error as the landmark is farther is conceivable. Therefore, the error estimation unit 107 estimates a large error in an object far from the own vehicle 1 and estimates a small error in an object near the own vehicle 1.

As one way of using the error output from the error estimation unit 107, for example, the geometric transform estimation unit 112A is caused not to output the geometric transform parameter to a plane equation in which the error estimation result by the error estimation unit 107 is equal to or more than a certain value. As a result, the feature collation unit 105B does not need to use the geometric transform parameter estimated by the geometric transform estimation unit 112A. The reason why such processing is performed is that it is expected that the geometric transform of the imaging plane by the feature collation unit 105B adversely affects the feature collation processing. In a case where the feature collation unit 105B does not use the geometric transform parameter, the geometric transform of the imaging plane is not performed, and the landmarks detected from the images 40a and 41a are collated as they are.

The image transform estimation unit (geometric transform estimation unit 112A) determines the range of error of the imaging plane to be subjected to imaging transform on the basis of the error of the imaging plane. Then, the geometric transform estimation unit 112A uses the estimation result of the error of the plane equation input from the error estimation unit 107 to determine whether the geometric transform parameter estimated for the imaging plane estimated by the imaging plane estimation unit 111 can be output. Since the range of error of the imaging plane is determined in this manner, the geometric transform parameter estimated for the imaging plane with a large error is not output.

In a case where the geometric transform parameter is not output from the geometric transform estimation unit 112A, the feature collation unit 105B collates the regions where the landmarks of the images 40a and 41a are detected without performing the geometric transform, and outputs the collation result to the position estimation unit 106.

In the external world recognition device 100C according to the fourth embodiment described above, the geometric transform estimation unit 112A determines whether to output the geometric transform parameter by using the estimation result of the error of the plane equation. In a case where the geometric transform parameter is not output, the feature collation unit 105B collates the region where the landmark is detected without performing the geometric transform. Therefore, the accuracy of collating the feature of the landmark is improved as compared with a case where the region geometrically transformed from the imaging plane using the plane equation having a large error is collated.

### Modification of Fourth Embodiment

Here, another method of using the error estimation result output by the error estimation unit 107 will be described.

FIG. 12 is a block diagram illustrating an internal configuration example of the geometric transform estimation unit 112A and the feature collation unit 105B according to a modification of the external world recognition device 100C. Here, configuration examples of the geometric transform estimation unit 112A and the feature collation unit 105B in the external world recognition device 100C illustrated in FIG. 11 will be mainly described.

It is empirically assumed that the parameter of the plane equation estimated from the imaging plane by the imaging plane estimation unit 111 is shifted by an error (±εα, ±εβ, ±εγ, ±εδ) with respect to the original parameter (α, β, γ, δ). In this case, the geometric transform estimation unit 112A duplicates the estimation result of the imaging plane by N patterns for each imaging plane within the range of the error width. There are various methods for duplication, and FIG. 12 illustrates a configuration example and a processing example of the geometric transform estimation unit 112A capable of executing one of the methods.

An image transform estimation unit (geometric transform estimation unit 112A) illustrated in FIG. 12 generates a plurality of imaging planes on the basis of the error of the imaging plane estimated by the error estimation unit (error estimation unit 107), and estimates a plurality of image transform parameters (geometric transform parameters) for each of the plurality of imaging planes. The geometric transform estimation unit 112A includes an imaging plane N generation unit 112A-1 and a geometric transform N estimation unit 112A-2.

The imaging plane N generation unit 112A-1 generates a plurality of imaging planes of N patterns by, for example, randomly assigning parameters so as to fall within the above error width and adding the parameters to the parameters of the plane equation estimated by the imaging plane estimation unit 111.

The geometric transform N estimation unit 112A-2 estimates a plurality of geometric transform parameters for each of the generated N-pattern imaging planes. Therefore, the geometric transform N estimation unit 112A-2 can estimate the N-pattern geometric transform parameters. The geometric transform N estimation unit 112A-2 estimated by the geometric transform N estimation unit 112A-2 is output to the feature collation unit 105B.

The feature collation unit (feature collation unit 105B) performs collation processing between a feature of a landmark detected from the first image (image 40a) subjected to image transform using a plurality of image transform parameters (geometric transform parameters) and a feature of a landmark detected from the second image (image 41a) a plurality of times, and outputs a result of the collation processing with high evaluation to the position estimation unit (position estimation unit 106). The feature collation unit 105B includes a feature N collation unit 105B-1 and a feature collation result selection unit 105B-2.

The feature N collation unit 105B-1 receives the estimation result of the N-pattern geometric transform parameters from the geometric transform N estimation unit 112A-2 of the geometric transform estimation unit 112A. The feature N collation unit 105B-1 performs N different collation processing on the feature of the landmark on the basis of the input estimation result of the N-pattern geometric transform parameters. The results of the N collation processing are output to the feature collation result selection unit 105B-2.

The feature collation result selection unit 105B-2 selects the result of the collation processing having the highest evaluation at the time of collation among the results of the N collation processing input from the feature N collation unit 105B-1, and outputs the selected result of the collation processing to the position estimation unit 106. The position estimation unit 106 estimates the position of the landmark on the basis of the result of the collation processing input from feature collation unit 105B.

The external world recognition device 100C according to the modification of the fourth embodiment described above includes the geometric transform estimation unit 112A and the feature collation unit 105B, so that the estimation result of the N-pattern geometric transform parameters can be obtained from the estimation result for the N-pattern imaging planes. Then, after the collation processing is performed N times according to the estimation result of the N-pattern geometric transform parameters, the result of the collation processing with the highest evaluation at the time of collation is selected. Therefore, even in a case where the parameter of the plane equation estimated by the imaging plane estimation unit 111 includes an error with respect to the original parameter, the position estimation unit 106 can accurately estimate the position of the landmark appearing in the images 40a and 41a.

### Fifth Embodiment

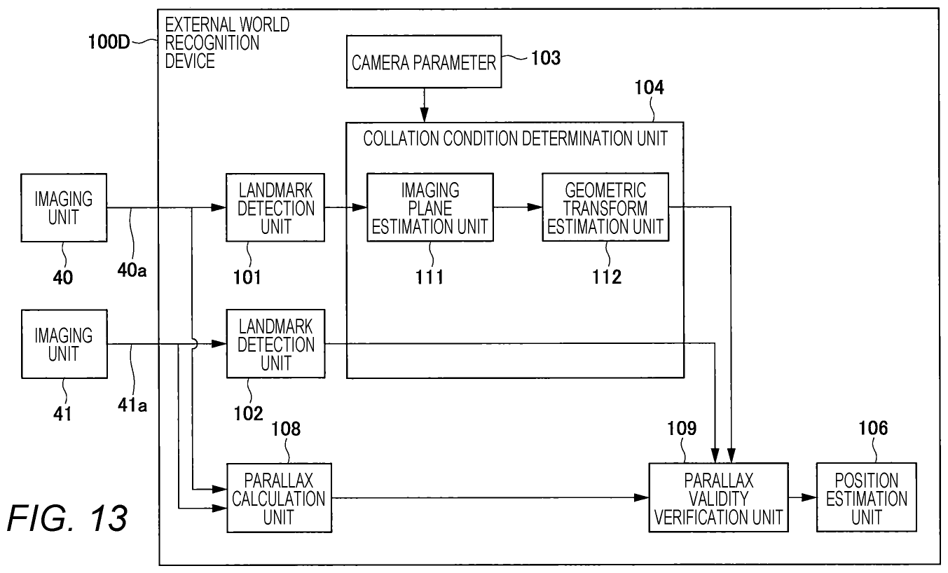

Next, a configuration example and a processing example of an external world recognition device 100D according to a fifth embodiment of the present invention will be described with reference to FIG. 13.

FIG. 13 is a block diagram illustrating an internal configuration example of the external world recognition device 100D.

The external world recognition device 100D includes a parallax calculation unit 108 and a parallax validity verification unit 109 in addition to the landmark detection units 101 and 102, the camera parameter 103, the collation condition determination unit 104, and the position estimation unit 106.

The parallax calculation unit (parallax calculation unit 108) calculates the parallax from a first image (image 40a) input from the imaging unit 40 and a second image (image 41a) input from the imaging unit 41, and collates the positions of the landmarks appearing in the first image (image 40a) and the second image (image 41a). That is, the parallax calculation unit 108 calculates the parallax between the images 40a and 41a without using the plane equation estimated by the imaging plane estimation unit 111 on the basis of the detection result of the landmark by the landmark detection unit 101. As a method of calculating the parallax by the parallax calculation unit 108, a known method of measuring the parallax may be used. The parallax calculation unit 108 calculates the parallax, and outputs a result of collating the positions corresponding to the same landmark shown in the images 40a and 41a to the parallax validity verification unit 109 as a second collation result.

The parallax validity verification unit 109 is a modification of the feature collation unit 105 according to the first embodiment. The feature collation unit (parallax validity verification unit 109) compares a first collation result obtained by collation between the feature of the landmark detected from the first image (image 40a) subjected to image transform using the image transform parameter (geometric transform parameter) and the feature of the landmark detected from the second image (image 41a) with a second collation result obtained by collation on the basis of the parallax, and outputs the first collation result or the second collation result to the position estimation unit (position estimation unit 106) on the basis of validity of the comparison result. That is, the parallax validity verification unit 109 collates the landmark of the image region geometrically transformed based on the geometric transform parameter estimated by the geometric transform estimation unit 112 using the plane equation estimated by the imaging plane estimation unit 111 with the landmark of the image region of the image 41a, and obtains the first collation result. Then, the parallax validity verification unit 109 compares the first collation result with the second collation result, and verifies the validity of the second collation result by the parallax calculation unit 108. For example, in template matching, a method of determining the validity of the collation result by the parallax validity verification unit 109 based on the level of the matching degree is assumed.

Note that, in the range in which the plane equation is estimated by the imaging plane estimation unit 111, it is assumed that the collation accuracy of the landmark geometrically transformed on the basis of the geometric transform parameter estimated by the geometric transform estimation unit 112 is high. However, in the method in which the parallax calculation unit 108 obtains the corresponding position of the landmark from the parallax calculated from the images 40a and 41a without the estimation of the plane equation by the imaging plane estimation unit 111, conditional branching by the plane equation does not occur. Therefore, if the parallax calculation unit 108 is made into hardware, there is an advantage that the parallax calculation processing can be easily speeded up.

Therefore, the parallax validity verification unit 109 limits the first collation result obtained by the plane equation and the geometric transform parameter, and uses the limited first collation result for the verification processing of whether the second collation result by the parallax calculation unit 108 is correct. The reason why the processing is performed in this manner is that the processing load of the parallax validity verification unit 109 increases when the parallax validity verification unit 109 obtains the first collation result obtained by the plane equation and the geometric transform parameter for all the landmarks commonly included in the images 40a and 41a.

The parallax validity verification unit 109 compares the limited first collation result with the second collation result, and in a case where the validity of the first collation result using the geometric transform is high, adopts the first collation result, and outputs the first collation result to the position estimation unit 106. For example, in the case of a landmark detected at a position close to the own vehicle 1, the parallax increases, and thus the validity of the second collation result obtained by collation using the parallax decreases. On the other hand, when the landmark is located at a position close to the own vehicle 1, the imaging plane is accurately estimated, so that the validity of the first collation result by the geometric transform is increased. Therefore, similarly to the external world recognition device 100 according to the first embodiment described above, the position estimation unit 106 estimates the position of the landmark using the first collation result.

Note that the parallax validity verification unit 109 compares the first collation result with the second collation result, and in a case where the validity of the second collation result is low, calculates the parallax of the images 40a and 41a and outputs the collated second collation result to the position estimation unit 106. For example, if the landmark is a landmark detected at a position far from the own vehicle 1, the parallax becomes small, and thus the validity of the second collation result obtained by collation using the parallax becomes high. On the other hand, since the landmark is located far from the own vehicle 1, the imaging plane is inaccurately estimated, so that the validity of the first collation result by geometric transform is lowered. Therefore, the position estimation unit 106 estimates the position of the landmark using the second collation result. Note that, in a case where the validity of the second collation result is low, there is a landmark having a large difference between the first collation result and the second collation result. Therefore, the parallax validity verification unit 109 may compare the first collation result with the second collation result again for the image region in which the landmark appears.

In the external world recognition device 100D according to the fifth embodiment described above, the validity of the collation result is verified by comparing the first collation result obtained by collation between the image region of the image 40a geometrically transformed based on the geometric transform parameter output from the collation condition determination unit 104 and the image region of the image 41a with the second collation result of the images 40a and 41a using the parallax calculated by the parallax calculation unit 108. Then, the parallax validity verification unit 109 determines the result to be output to the position estimation unit 106 as either the first collation result or the second collation result according to the validity of the collation result. In a case where the validity of the comparison between the first collation result and the second collation result is low, the position estimation unit 106 can estimate the position of the landmark using the second collation result. Therefore, either the first collation result or the second collation result is output to the position estimation unit 106 depending on whether the landmark is located close to or far from the own vehicle 1. Therefore, the position estimation unit 106 can estimate the position of the landmark at various positions at high speed.

### [Modifications]

Note that, in each of the above-described embodiments, the present invention has been described as an external world recognition device mounted on the vehicle 1. However, the external world recognition device may be used in, for example, a self-propelled robot including a plurality of cameras, or an infrastructure monitoring system that monitors the premises by videos captured by a plurality of cameras. In the infrastructure monitoring system, for example, a configuration in which a plurality of cameras are installed at one place is assumed.

Furthermore, in addition to the above-described embodiments, it is also possible to configure an external world recognition device having a function of directly calculating a distance from a result of machine learning. In this case, when the external world recognition device can calculate the distance to the landmark by machine learning, the distance can be calculated when the landmark is detected from the image, and the calculation load of the external world recognition device can be reduced.

In addition to the above-described embodiments, the external world recognition device may perform parallax matching used in a conventional stereo camera. In this case, the external world recognition device can refer to the result estimated to have the best collation result from the results of collating the plurality of images, and can further estimate the positional relationship for each landmark using map information prepared in advance.

Note that the present invention is not limited to the above-described embodiments, and it goes without saying that various other application examples and modifications can be taken without departing from the gist of the present invention described in the claims.

For example, the above-described embodiments describe the configurations of the device and the system in detail and specifically in order to describe the present invention in an easy-to-understand manner, and are not necessarily limited to those having all the described configurations. Furthermore, a part of the configuration of the embodiment described here can be replaced with the configuration of another embodiment, and furthermore, the configuration of another embodiment can be added to the configuration of a certain embodiment. Furthermore, some of the configurations of each embodiment may be omitted, replaced with other configurations, and added to other configurations. Furthermore, only control lines and information lines considered to be necessary for explanation are illustrated, but not all the control lines and the information lines for a manufacture are illustrated. In practice, almost all the configurations may be considered to be connected to each other.

### REFERENCE SIGNS LIST

1, 2 vehicle
40, 41 imaging unit
40a, 41a image
100 external world recognition device
101, 102 landmark detection unit
103 camera parameter
104 collation condition determination unit
105 feature collation unit
106 position estimation unit
111 imaging plane estimation unit
112 geometric transform estimation unit
113 imaging plane estimation unit
114 geometric transform estimation unit

1. An external world recognition device comprising:
a first landmark detection unit that detects a landmark on a basis of a first image acquired from at least a first imaging unit among a plurality of imaging units in which at least a part of an imaging visual field with respect to an external world overlaps;
a second landmark detection unit that detects a landmark on a basis of a second image acquired from a second imaging unit among the plurality of imaging units;
an imaging plane estimation unit that estimates an imaging plane in the first image on a basis of a detection result of the landmark by the first landmark detection unit;
an image transform estimation unit that estimates an image transform parameter matching an imaging plane in the second image on a basis of information on the imaging plane estimated by the imaging plane estimation unit and imaging parameters of the plurality of imaging units;
a feature collation unit that collates a feature of the landmark detected from the first image subjected to image transform using an image transform parameter by the image transform estimation unit with a feature of the landmark detected from the second image; and
a position estimation unit that estimates a three-dimensional position of the landmark on a basis of a collation result of the feature collation unit.

2. The external world recognition device according to claim 1, wherein
the imaging plane estimation unit estimates the imaging plane on a basis of a size of the landmark and a distance to the landmark.

3. The external world recognition device according to claim 2, wherein
the imaging plane estimation unit estimates the imaging plane in an image region in which the landmark is imaged.

4. The external world recognition device according to claim 3, wherein
a plurality of imaging plane estimation units and a plurality of image transform estimation units are provided for the landmark detected from the first image and the landmark detected from the second image, respectively, and
the feature collation unit acquires a collation result between a result of image transform of the first image by using the image transform parameter estimated by one of the image transform estimation units and the second image, acquires a collation result between a result of image transform of the second image by using the image transform parameter estimated by other one of the image transform estimation units and the first image, compares the respective collation results, and in a case where the landmark detected from the first image and the landmark detected from the second image are collated at a same three-dimensional position, gives high reliability to the collation result.

5. The external world recognition device according to claim 3, comprising
a transform selection unit that selects, from among a plurality of landmarks detected from the first image and the second image, the landmark at a short distance from an own vehicle, and selects the image transform parameter estimated by the image transform estimation unit for the selected landmark, wherein
the feature collation unit performs image transform of the landmark detected from the first image by using the image transform parameter selected by the transform selection unit.

6. The external world recognition device according to claim 5, wherein
the transform selection unit preferentially selects the landmark having an attribute that greatly affects traveling of the own vehicle.

7. The external world recognition device according to claim 3, comprising
an error estimation unit that estimates an error of the imaging plane estimated by the imaging plane estimation unit, wherein
the image transform estimation unit determines a range of error of the imaging plane to be subjected to image transform on a basis of an error of the imaging plane.

8. The external world recognition device according to claim 7, wherein
the image transform estimation unit generates a plurality of imaging planes on a basis of an error of the imaging plane estimated by the error estimation unit and estimates a plurality of image transform parameters for each of the plurality of imaging planes, and
the feature collation unit performs collation processing between a feature detected from the first image subjected to image transform using the plurality of image transform parameters and a feature detected from the second image a plurality of times, and outputs a result of the collation processing with high evaluation to the position estimation unit.

9. The external world recognition device according to claim 3, comprising
a parallax calculation unit that calculates a parallax from the first image and the second image and collates a position of a landmark appearing in the first image and the second image, wherein
the feature collation unit compares a first collation result obtained by collation between a feature of the landmark detected from the first image subjected to image transform using the image transform parameter and a feature of the landmark detected from the second image with a second collation result obtained by collation on a basis of the parallax, and outputs the first collation result or the second collation result to the position estimation unit on a basis of validity of a comparison result.

10. An external world recognition method comprising:
a process of detecting, by a first landmark detection unit, a landmark on a basis of a first image acquired from at least a first imaging unit among a plurality of imaging units in which at least a part of an imaging visual field with respect to an external world overlaps;
a process of detecting, by a second landmark detection unit, a landmark on a basis of a second image acquired from a second imaging unit among the plurality of imaging units;
a process of estimating, by an imaging plane estimation unit, an imaging plane in the first image on a basis of a detection result of the landmark by the first landmark detection unit;
a process of estimating, by an image transform estimation unit, an image transform parameter in accordance with an imaging plane in the second image on a basis of information of the imaging plane estimated by the imaging plane estimation unit and imaging parameters of the plurality of imaging units;
a process of collating a feature of the landmark detected from the first image subjected to image transform using an image transform parameter by the image transform estimation unit with a feature of the landmark detected from the second image; and
a process of estimating a three-dimensional position of the landmark on a basis of a result of collation processing.
